(19) United States
(12) Patent Application Publication
(10) Pub. No.: US 2006/0041496 A1
(43) Pub. Date: Feb. 23, 2006

(54) Method and system for automating proposals involving direct and indirect sales

(76) Inventor: Maged Amin, Cairo (EG)

Correspondence Address: STEPTOE & JOHNSON LLP, 1330 CONNECTICUT AVENUE, N.W., WASHINGTON, DC, 20036, US

(21) Appl. No.: 10/921,335

(22) Filed: Aug. 19, 2004

(51) Int. Cl. G06Q 40/00

(52) U.S. Cl. 705/37; 705/1

(57) ABSTRACT

A sales automation system is described. The system can be customized to generate complex proposals involving direct and indirect sales. The system allows users to manage sales projects comprising complete solutions. Proposals are generated by integrating third party products and services offering and by using a pool of products stored in the system catalog. Requests to third party suppliers and service providers are managed by the system and integrated after evaluation in the final proposal to the customer. Search and allocation of products allows users to quickly identify products from a large data pool. Proposal items are structured in a way that enable flexible calculations of resale values based on market conditions and specific variables related to third party suppliers. The system is structured to enable proposals offering to multiple customers for a single project. This structure is extended beyond the proposal preparation cycle until the order phase.

### FIELD OF THE INVENTION

The present invention relates to a computerized system for selling goods and services, and more particularly to a method and system for handling complex proposals involving direct and indirect sales.

### BACKGROUND OF THE INVENTION

Product vendors and service providers are looking for new ways to provide better customer service and to manage complex sales processes. The workload in bids and proposals departments is usually high and requires plenty of resources. This represents a real challenge for sales organizations, as they have to accurately respond to customers' requests and meet deadlines. In many situations, during the pre-award phase of a sales project, organizations are not able to fulfill customers requests in due dates and accordingly, loose customers' confidence as well as sales opportunities. This problem is particularly common in projects oriented sales organizations that are usually requested to submit complex proposals in a short period of time.

In the Pre-award phase, product vendors and service providers are often requested to submit a complex business proposal, to present technical and financial aspects of their products and/or services. A complex sales proposal often comprise multiple sections describing products and or services. Beside prices quotations, proposal submittals may include cover letters, table of contents, dividers, terms and conditions among other documents such as drawings, certificates, reference lists, etc. Accurate, and well-organized proposals give a first good impression about the products and services.

Considering the number of tasks involved in preparing a proposal, managing a large number of proposals by a limited number of sales professionals at peak load becomes a big challenge. The generation of proposals involves a number of complicated steps that include: (1) Registration of Customers Request for Proposals information (CRFP), (2) Revision of specification requirements of the customer to request, complementary items from third party Product Vendors and Service Providers, (3) Following up requests for quotations submitted to suppliers (if applicable), (4) Selection and evaluation of products and services that fulfill the original customer requirements based on available information and additional third party offers, (5) Preparation of technical and financial proposals.

There is a big difference between direct and indirect sales. Direct sales are usually generated by product manufacturers and original service providers, while indirect sales are provided by resellers, agents, contractors, industrial system integrators, etc. Systems and methods for direct sales are completely different than for indirect sales. Therefore, traditional solutions designed for direct sales cannot satisfy the indirect sales requirements and are very limited in addressing the “Buy” and “Resale” scenario. The combination of direct and indirect sales results in further complexity. In many cases, industrial entities offering combination of direct and indirect sales are often selling systems or solutions on a turnkey basis. Good examples of entities selling solutions are industrial system integrators and contractors. In the case of “selling solutions” the sales automation system must provide room for both methodologies “Direct” and “Indirect”. Selling solutions usually involve many complex requirements that need to be solved. Unique characteristics and needs for selling solutions in the pre-award phase of the sales process are: (1) Minimizing the time consumed in the proposal creation, (2) Costing method addressing both direct and indirect sales of products and services, (3) Handling third Party offerings, (4) configuration of complex items and subsystems, (5) Enabling a quality control mechanism for judging the proposal quality.

The customer requesting a proposal can be the end-user or an intermediate distributor, reseller, contractor, system integrator, etc. In many situations, multiple customers are associated with a single sales project in the pre-award phase of the sales process. This situation is often associated with RFQ communicated by contractors or resellers who are ultimately proposing their own solution to an end user. Ultimately, one customer will be awarded the project by the end-user in a later phase. In such case, Customers Requests for Proposals (CRFP) are received from a plurality of customers for the same project during the study phase. The content and scope of the CRFP may vary from one customer to another depending on the customer approach that may be influenced by variations in designs, estimation for quantities, etc. Proposals in this case have to be generated for each customer to reflect his unique requirements. In many situations, proposals submitted to multiple customers in conjunction with one project may be identical in technical content, but has to reflect different pricing policies. Pricing policies are usually a result of pre-bid agreements, special discount agreements with customers who buy large volumes, etc. Therefore, duplication of proposals must be avoided in case of identical CRFP, while maintaining the possibility of granting different discount levels in such condition. Traditional systems are not structured to address these situations. Introducing the a/m variations in traditional systems that do not allow a plurality of customers for the same proposal may result in processing tens of sales projects instead of a single project, in order to reflect the different cases described. Again, such approach is time consuming and has severe impact on managing the projects information. Failure to address these situations may results in gaps of information and considerable impact and doubt about the completeness and integration of the sales data.

In the case of indirect sales, the resale value for products and services is highly dependant on destination market conditions. This case exists in sales between different geographic territories. Market conditions are governed by different factors including the currency type, transportation costs, clearance costs, customs, local taxes, profit margins, etc. Again, these factors may vary from one item to another in the same sales project. Reasons for such variations may be due to the presence of items from different third party vendors. It could also be due to variations in calculation criteria for different items of the same vendor such as customs associated with certain categories of products. In traditional systems handling direct sales, resale values are linked to the vendor side and are predefined and calculated following certain discount rules and involving one type of currency for a given transaction. In many situations, a supplier can also be used only to base the price estimation for item(s) and substituted in the proposal by another. This situation is common in case of proposing turnkey systems or solutions without revealing information of sub-suppliers, sub-contractors, etc. An easy method for addressing resale values estimation on the level of selected groups of items is vital in situations involving complex direct and indirect sales. This method must be integrated within the products and services selection phase of the proposal preparation and must consider project conditions, customer conditions, territory conditions, supplier conditions, etc. for each proposed item.

Selection of products and services in course of preparing a proposal is a difficult task. Difficulties are clear while trying to locate a specific product or service having specific variation from a large pool of products and services. Traditional quotation configuration systems are depending mainly on product and service coding systems or more advanced methods for searching and allocation of products that still cannot be practical in many cases. Furthermore, this requires the user to know the code number, which in reality does not always (or often) hold true. Usually, with the complications associated with products configuration, it is always difficult to perform the selection of the product and services for each line-item of the quotation without switching between screens. Switching between screens becomes a real problem that can greatly affect the efficiency of the quotation configuration system specially when dealing with hundreds of line-items in one proposal. It would therefore be desirable to have a system, which is very user-friendly, and enable quick product and service selection during the proposal preparation.

Complex proposals for selling solutions comprise hundreds or thousands of line items. Combinations of direct and indirect sales items of products and/or services with different arrangement, interrelations, resale basis and conditions, represent a big challenge. Variables associated with proposal generation during the pre-award phase are too complicated and require extensive efforts and lots of hours and resources by bids and proposals professionals, sourcing specialists and other supporting departments. Usually more pressure is added by time constraints as the submission of such complex proposals must meet tight dead lines. Furthermore, slight changes in sales items configuration may result in many complications and the inability to trace deviations and possible errors. Mistakes in proposals for selling complex solutions are very common and usually have severe financial implications. It would therefore be desirable to have a system, which can handle complex proposals and enable efficient costing management and control for direct and indirect sales items on all levels considering interrelations, complex variables and conditions.

Proposals may also comprise subsystems of products and/or services. A single proposal line item or Subsystem item on the other hand may consist of many sub items of products and/or services adding to the complexity of the proposal. Sub items are layers of products and/or services that represent a single line item with one resale value. The supplier and supply costing basis and conditions may be different on the level of items or sub items. This random distribution represents a challenge for defining resale values and relevant terms and conditions on the level of line-items and sub-items.

In order to judge the quality of complex proposals in conjunction with selling solution, a mechanism must be used. The business case is usually a technique for the quality control of complex proposals. A business case enables a decision-maker to analyze the business proposal in a thorough and concise manner, with the objective of making an accurate decision. Accurate decisions limit risk while increasing chances for success. The centerpiece of a business case is the pro-forma, or projection of revenue and expenses. A business case is very time consuming as it reflect all details in the proposal. Any change in direct and indirect sales items affect the business case study. Changes in the proposal require a big effort for reestablishing a new business case that reflect the current status. Due to limited resources, and time constraints, the business case is seldom used in conjunction with proposal generation. It would therefore be desirable to have a system, which can provide a quality control mechanism and handle the generation of the business case and reflect any changes in the proposal.

Sourcing products and services from third party to complete a sales proposal require time and efforts for the creation and tracking of requests to suppliers based on original customers RFQs. Requests prepared to suppliers are not necessarily identical to customer RFQs. Therefore, considerable processing might be needed to create, track, and ultimately integrate third party quotations in the final proposal to the customer. It would therefore be desirable to have a system, which can handle complex sourcing and enable integration of third party quotation into the final solution presented to the customer.

The present invention therefore solves many problems of traditional sales automation and proposals generation systems, by providing a user-friendly, customizable system, which in turn provides consistent service, reduced training time, and reduced duration for sales proposal configuration.

### SUMMARY OF THE INVENTION

According to our invention we provide a system and a method to enable sales professionals and sourcing specialists, to effectively create complex proposals involving direct and indirect sales in addition to managing different aspects of the sales processes during the different project development phases comprising the pre-award and order phases.

One embodiment may include a method and system for managing requests from a plurality of customers in conjunction with a single project. A group of potential customers is created and the pattern of customers variation is defined throughout the different phases of the sales process for ultimate definition of the purchasing customer.

Another embodiment include a method and system for computing the resale value in addition to defining terms and conditions on the level of quotation line-items and sub-items using local costing domains.

Another embodiment include a method and system for the creation and processing of complex subsystems. Global costing domains are defined for regular catalog line-items. A global supplier group identifier is created for general supplier product items. The global supplier group identifier is used for modeling of group of suppliers to a general supplier product.

Another embodiment include a method and system for establishing the relation between line-items of the different objects in different phases of the sales process based on the backbone tree. A supporting package line-items is created and the user generate more than one request batch for efficient management of sourcing requests directed to third party suppliers.

Another embodiment include a method and system for sourcing comprising generation and managing requests to third party suppliers and service providers. Requests associated with sourcing products and services from third party comprise (1) request creation, (2) request communication, and (3) suppliers offers evaluation. The construction of the backbone tree is the base for processing sourcing operations. Request associated with general supplier product based items are automatically generated.

As used herein, the following terms have the following meanings:

The word “quotation” and the word “proposal” are used throughout this document generally to describe a set of documents comprising at least the price quotation line-items prepared by the user of the system in response to customers request for quotation or proposal unless otherwise stated or explained.

The term “supplier quotation” and the term “third party quotation”, unless otherwise stated, are used throughout this document—in the context of sourcing products and services from third party—to describe a set of documents comprising at least the price quotation line-items offered by third party vendors and service providers in response to requests for quotation generated by the system.

The word “product” is used throughout this document generally to describe anything the customer may request directly or indirectly, and may be tangible (e.g. motor) or non-tangible (e.g. a service).

The term “direct sales” is used throughout this document to describe in house sales items or products generally offered for sale by the system in response to customers request for quotation or proposal.

The term “indirect sales” is used throughout this document to describe third-party sales items or products generally offered for sale by the system in response to customers request for quotation or proposal. In other words, the term “indirect sales” is addressing the “Buy” and “Resale” scenario.

The method and system of our invention allows the sales professionals and sourcing specialists to source and integrate third party products more effectively in the solution, in addition to effectively generating complex proposals based on direct sales and indirect sales, representing a complete solution to the customers.

### BRIEF DESCRIPTION OF THE DRAWINGS

FIG. 1 illustrates a sales automation system environment.

FIG. 2.a illustrates a system for direct and indirect selling.

FIG. 2.b illustrates the Request Management Component.

FIG. 3 illustrates the flow diagram for customers' patterns variation with the different project phases.

FIG. 4 is a diagram illustrating the change of the customers' patterns with the different project phases for a project involving multiple customers' requests.

FIG. 5 illustrates an example quotation creation workflow.

FIGS. 6a and 6b illustrates the flow diagram of products configuration and allocation during the proposal preparation.

FIG. 7 is a diagram illustrating the logical model for handling complex multi-layers proposals.

FIG. 8.a illustrates the relation between the local costing domains and the proposal generation cycle.

FIG. 8.b represents screen displays illustrating the use of local costing domains during the preparation of the proposal.

FIG. 9 illustrates an example complex subsystem creation and processing workflow.

FIG. 10.a illustrate the backbone tree.

FIG. 10.b illustrate the work flow for sourcing and technical configuration phases based on the backbone tree.

FIG. 11 illustrate a diagram for association of global supplier group identifier to general supplier products.

FIG. 12 illustrate a diagram for automatic generation of requests associated with general supplier product based items.

FIG. 13 illustrate the business case generation workflow.

### DETAILED DESCRIPTION OF THE PREFERRED EMBODIMENTS

In an exemplary embodiment, the sales automation system automates sourcing and quoting processes in order to streamline the direct and indirect sales of products and services in a project centric environment. It involves generating a price quote from data gathered such as catalog and non catalog data, supplier quotations and terms, trade partners data, and sales project data and executing the quote generation according to business rules adopted via the system.

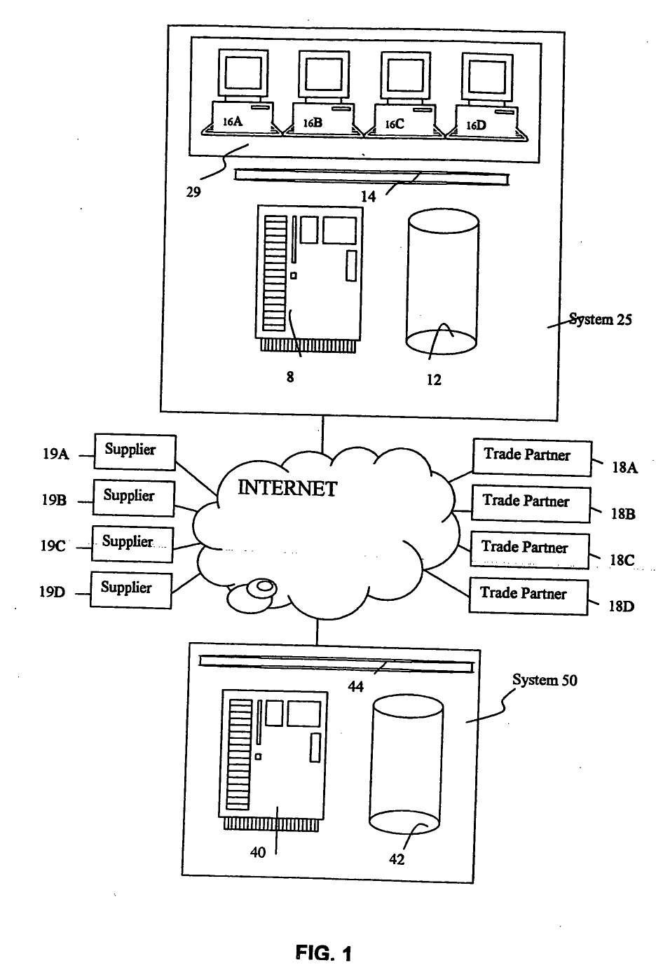

In terms of structure, reference is now made to FIG. 1. Therein depicted is a block diagram representing a network system 10 for implementing the sales automation system of the present invention. System 10 includes system 25 comprising a server 12 connected through a communications network 14 to terminals 16A-16D. System 25 may be central office of a business. Network 14 may comprise a Local Area Network (LAN), a Wide Area Network (WAN), Metropolitan Area Network (MAN), or other network configuration known in the art. Further, network 14 may include wireless connections, telephony-based communications, radio-based communications, and other network-based communications.

System 25 is preferably operating a combination of programming languages software such as Visual Basic (VB), C+ or the like and web server software or similar program designed to accommodate various forms of communications via internal network 14 and any external network (e.g., Internet, Extranet). Any web server software or similar program that handles general communications protocols and transport layer activities could be used as appropriate for the network protocol in use. System 25 preferably executes the sales automation system of the present invention, however, it could alternatively be executed under an outsourced arrangement via an Applications Services Provider (ASP) under a subscription agreement or other suitable mechanism. The sales automation application may be one of many business applications employed by system 25 which, in combination, constitute its Enterprise Resource Planning (ERP) suite and other suitable suites. System 25 may also execute a bridging system for integrating data from various databases utilized by System 25 for mapping together product information on product catalog component (e.g., article number, article name, and article description) with relevant, associated business characteristics such as prices and contract terms from which System 25 can review and process. System 25 may also execute one or more systems for facilitating the transfer and execution of requests to suppliers and integrating this information into its sales automation system.

Data storage device 8 is also included in System 25 and may be any form of mass storage device configured to read and write database type data maintained in a file store (e.g., a magnetic disk data storage device). Information stored in data storage device 8 may be retrieved and manipulated by database management software executed via server 12 such as Oracle.RTM, Sybase.RTM, Microsoft.SQL Server.RTM, Microsoft Access.RTM, IBM's DB/2.RTM software or the like. Data storage device 8 provides a repository for a variety of databases, including a catalog database, and administrative database (e.g., for storing approved vendor lists, access and security authorizations, etc). Also stored in data storage device 8 may be a catalog or collection of tables used by the bridging component described above in conjunction with the sales automation system in order to integrate various types of data received from different sources. Although a client/server system architecture has been described for implementing the sales automation system, it is understood that alternative network configurations known in the art may be utilized by System 25 in order to realize the advantages of the present invention. A sales automation (SA) group 11 at System 25 administers the execution and performance of the sales automation software.

Department 29 represents a sales unit of System 25. Department 29 purchases products and/or services from its trading partners for resale (or indirect sale). Department 29 may itself offer in-house products and services for direct sale. Department 29 may include sourcing specialists and a bids and proposal team which facilitates the ‘request for quote’ (RFQ) processes on behalf of customers and is preferably one of a number of Departments of System 25. Department 29 may include Terminals 16A-16D, software, and network communications capabilities for generating, communicating, and executing RFQ-related information to customers and trading partners and for facilitating the objectives set forth via the sales automation system as will be described further herein. Terminals 16A-16D may be network PCs, which allows users access to applications executed via server 12 in a client/server architecture mode. Client/server network configurations are well known in the industry and will be appreciated by those skilled in the art.

Trade partners systems 18A-18D may be independent suppliers doing business with System 25 and providing product electronic catalogs periodically updated at System 25 under an agreement. Trade partners systems 18A-18D may be located in various regions of the world. System devices utilized by Trade partners systems 18A-18D may include communications hardware and software such as web-enabled general purpose computer devices with Internet access for communicating with System 25 as needed. Further, Trade partners systems 18A-18D may include e-catalog processing and publishing capabilities for directly procuring products and services and business data pursuant to the technique adopted by System 25.

System 50 is preferably operating a web server software or similar program designed to accommodate various forms of communications via external network (e.g., Internet, Extranet). System 50 preferably partially executes data related to trade partners in conjunction with the request management component of the present invention possibly among other applications. However, it could alternatively be executed under an out-sourced arrangement via an Applications Services Provider (ASP) under a subscription agreement or other suitable mechanism. System 50 execute a bridging system for integrating data from the sales automation system and various databases utilized by System 25 for mapping together request information on request management component. Data storage device 42 is also included in system 50 and may be any form of mass storage device configured to read and write database type data maintained in a file store. Information stored in data storage device 42 may be retrieved and manipulated by database management software executed via server 40. Data storage device 42 provides a repository for a request management database (e.g., a database for storing request and supplier quotation detail). Also stored in data storage device 42 may be a catalog or collection of tables used by the bridging component described above in conjunction with the request management system in order to integrate various types of data received from different sources. In another embodiment of the invention, system 50 is an integrated subset of system 25.

Suppliers systems 19A-19D provide products and services to system 50 and ultimately to Department 29 of System 25 based on requests published by System 25 to system 50. Suppliers systems 19A-19D may be located in various regions of the world. System devices utilized by Suppliers systems 19A-19D may include communications hardware and software such as web-enabled general-purpose computer devices with Internet access for communicating with System 25 as needed.

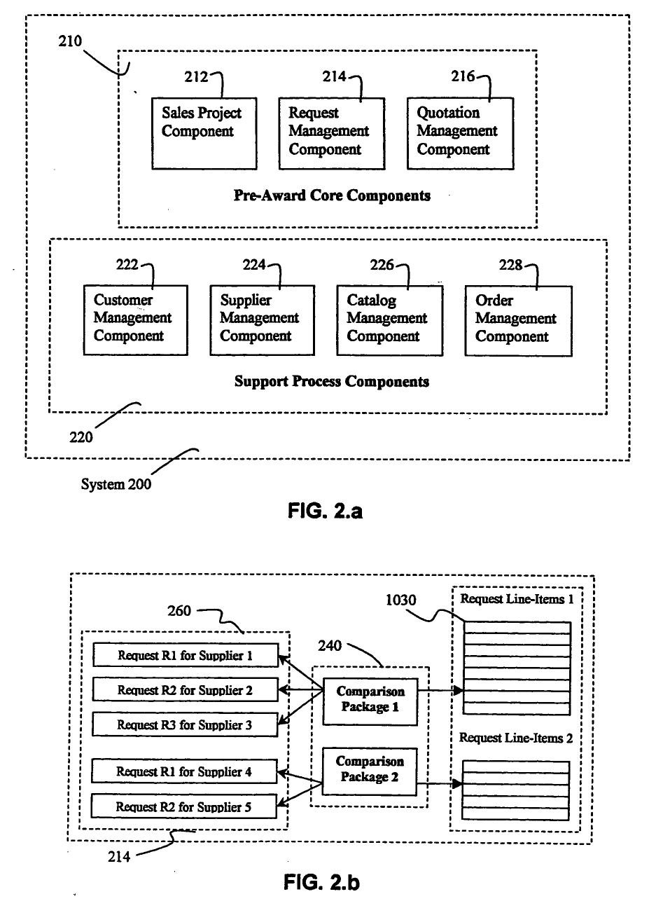

FIG. 2.a illustrates system 200, the preferred software components for direct and indirect selling. During the pre-award phase system 200 is used for facilitating direct and indirect selling and comprise: processing customers Requests for Quotation (RFQ) information based on receiving RFQ comprising a plurality of request line-items each corresponding to a product and/or service, generating requests and processing information related to sourcing products and services from partners 18A-18D and suppliers 19A-19D for indirect selling, generating a proposal comprising a plurality of line-items based on catalog and non-catalog products and services, and assessing of proposal quality before final proposal submission to customer.

System 200 is configured within system 10. System 200 is divided into three pre-award phase core process components 210, which relates to the pre-award phase of the sales process in addition to other phases, namely a sales project component 212, a request management component 214, and a quotation management component 216. Additional support components 220 may be integrated into system 200 to support the pre-award phase core components 210. For example, in the disclosed embodiment, four support process components provide support to the pre-award core components 210. Support components 220 typically include, a customer management component 222, a supplier management component 224, a catalog management component 226 and an order management component 228.

The sales project component 212 is provided to assist sales professionals in managing the Requests for Quotation (RFQ) received by the customers, and for tracking sales projects. The sales project component 212 maintains information regarding customer requests. In one embodiment, definition for customer request information object maintained at the sales project component 212 may include, in any suitable combination, without limitation, (1) a project ID, (2) a sales project name, (3) a due date (4) a purchasing customer name, (5) a category, (6) a status, (7) a description, (8) a sales person name. A potential customer group is defined as a group of customers requesting quotations relevant to the same sales project. A default general customer is defined as a temporary purchasing customer that exists as long as a permanent purchasing customer is not decided. Only one customer from the potential customers group may become the permanent purchasing customer that replace the default general customer at a given phase of the sales process. Customer request information may be related to a potential customer group. This allow for the modeling of multiple RFQ information for the same sales project. In one embodiment, the sales project component 212 may maintain for each potential customer, in any suitable combination, without limitation, (1) a project ID—links potential customer to customer requests, (2) a customer ID, (3) a date, (4) a contact name, (5) a reference number, and (6) a description. The request management component 214 illustrated in FIG. 2.b is provided to assist sales professionals and sourcing specialists for generating and communicate requests for products and services to suppliers 19A-19D, to compare quotations received from suppliers 19A-19D and to process the quotations received from the winner suppliers for final integration into the sales solution. The request management component 214 maintains information regarding the request object 260. In one embodiment, definition for request object 260 maintained at the request management component 214 may include, in any suitable combination, without limitation, (1) request ID, (2) project ID, (3) quotation ID, (4) base currency, (5) description, (6) status, (7) date, (8) validity, (9) Supplier ID, (10) comparison package ID. The request management component 214 maintains information regarding the request line-item object 1030. In one embodiment, definition for request line-item object 1030 maintained at the request management component 214 may include, in any suitable combination, without limitation, (1) line-item ID, (2) quotation ID, (3) product ID, (4) product variation ID, (5) product UOM, (6) quantity, (7) cost price, (8) supplier ID, (8) Comparison package ID. The request management component 214 maintains information regarding the comparison package object 240. The comparison package object 240 is used to group consistent request line-items and associate them with groups of suppliers for similar comparison basis. In one embodiment, definition for the comparison package object 240 maintained at the request management component 214 may include, in any suitable combination, without limitation, (1) comparison package ID, (2) date, (3) project ID, (4) quotation ID, (5) description, (6) global group identifier—links comparison packages associated with general supplier products to suppliers.

The quotation management component 216 is provided to assist sales professionals for generating quotations to customers based on catalog and non-catalog items. The quotation management component 216 maintains information regarding the quotation object. In one embodiment, definition for quotation object maintained at the quotation management component 216 may include, in any suitable combination, without limitation, (1) quotation ID, (2) project ID, (3) name, (4) base currency, (5) description, (6) status, (7) date, (8) validity, (9) revision. The quotation management component 216 maintains information regarding the quotation line-item object. In one embodiment, definition for quotation line-item object maintained at the quotation management component 216 may include, in any suitable combination, without limitation, (1) line-item ID, (2) quotation ID—links line-item to quotation, (3) product ID, (4) product variation ID, (5) product UOM, (6) quantity, (7) cost price, (8) resale price, (9) local costing domain ID, (10) supplier ID, (11) source—define the source of line-item either catalog or non-catalog. The quotation object may be related to a quotation customer group, which is a subset of the potential customer group defined in the sales project component. This allows for modeling of multiple quotations to multiple customers of the potential customer group. In one embodiment, the quotation management component 216 may maintain for each customer identified in the quotation customer group, in any suitable combination, without limitation, (1) a quotation ID—links potential customer to quotation, (2) a customer ID, (3) a date, (4) a reference number, and (5) a description. The quotation object may be related to a customer discount group which is a subset of the potential customer group defined in the sales project component 212. This allow for modeling of multiple discounts to multiple customers of the potential customer group. In one embodiment, the quotation management component 216 may maintain for each customer identified in the customer discount group, in any suitable combination, without limitation, (1) a quotation ID—links potential customer to quotation, (2) a customer ID, (3) a discount percentage, (4) a date, (5) a reference number, and (6) a description.

The catalog management component 226 is an important support component provided to assist sales professionals for building and managing product catalogs and other proposal building blocks. The catalog management component 226 maintains information regarding the product object. In one embodiment, definition for product object maintained at the catalog management component 226 may include, in any suitable combination, without limitation, (1) a product ID, (2) a category, (3) a product name, (4) a product description, (5) a unit of measure, (6) a supplier ID, (7) a base currency, and (8) a product type—Products stored in the catalog comprise tow types: regular catalog products associated with one specific supplier and general supplier products associated with multiple suppliers. General supplier products are products or services that can be sourced from a plurality of suppliers. Therefore, information relevant to general supplier products must not be specific to a particular supplier. Each product may be related to multiple product variation. Product variations are particularly useful in configuring products having identical main specifications but differ only in one or two feature such as size, color, etc. and possibly in price. In one embodiment, definition for product variation object maintained at the catalog management component 226 may include, in any suitable combination, without limitation, (1) a product ID—links product variation to product, (2) a product variation ID, (3) a cost price, (4) a reference number, and (5) a description

One of the quotation building blocks is the complex product. A complex product object is used to model a product consisting of a plurality of products and/or services. The catalog management component 226 maintains information regarding the complex product object. A Complex product is created at the product catalog level. A Complex product consist of a parent product component. Each product may be related to a multiple product line-item object in a parent/child configuration. Product line-items are particularly useful in configuring complex products consisting of multiple products and services. In one embodiment, the catalog management component 226 may maintain for each product line-item object, in any suitable combination, without limitation, (1) a product ID—links product line-item to product, (2) a product line-item ID, (3) a unit of measure, (4) a quantity, (5) a cost price, (6) a reference number, and (7) a description and (10) source—define the source of line-item either regular catalog product or general supplier product. The Total unit cost of a Complex product is equal to the sum of the cost multiplied by the quantity of the child table line-items.

Another quotation building block is the subsystem. A subsystem consists of a set of items created and grouped in subsystems library. These line items are saved in the library and act as a template during the quotation creation. The structure of these line items is similar, but not identical to the quotation line-items. The catalog management component 226 maintains information regarding the subsystem library object. In one embodiment, the definition for subsystem library object is maintained by the catalog management component 226 and may include, in any suitable combination, without limitation, (1) subsystem ID, (2) name, (3) date, and (4) description. The catalog management component 226 maintains information regarding the Subsystem object. A subsystem object is used to model a plurality of quotation line-items comprising products and/or services. In one embodiment, the definition for a subsystem object maintained at the catalog management component 226 may include, in any suitable combination, without limitation, (1) line-item ID, (2) subsystem ID, which links a line-item to a subsystem library, (3) product ID, (4) product variation ID, (5) product UOM (unit of measure), (6) quantity, (7) cost price, (8) global costing domain ID, (9) supplier ID, and (10) source, which defines the source of line-item as either a regular catalog product or general supplier product. A user may related each line-item of the subsystem object to a secondary subsystem layer in a parent/child configuration. In one embodiment, the catalog management component 226 may maintain, for each subsystem line-item, in any suitable combination, without limitation, (1) sub line-item ID, (2) line-item ID—links sub line-item to line-item, where the line-item ID is an identifier for the record and the sub-line item ID provides the link, (3) product line-item ID, (4) product ID, (5) product variation ID, (6) product UOM (unit of measure), (7) quantity, (8) cost price, (9) global costing domain ID, (10) supplier ID, and (11) source, which defines the source of a line-item as either regular catalog product or general supplier product. The total unit cost of a line-item of a subsystem is equal to the sum of the cost multiplied by the quantity of the child table line-items. Subsystem line-items may include general supplier products and as a result, may also have an associated global group identifier.

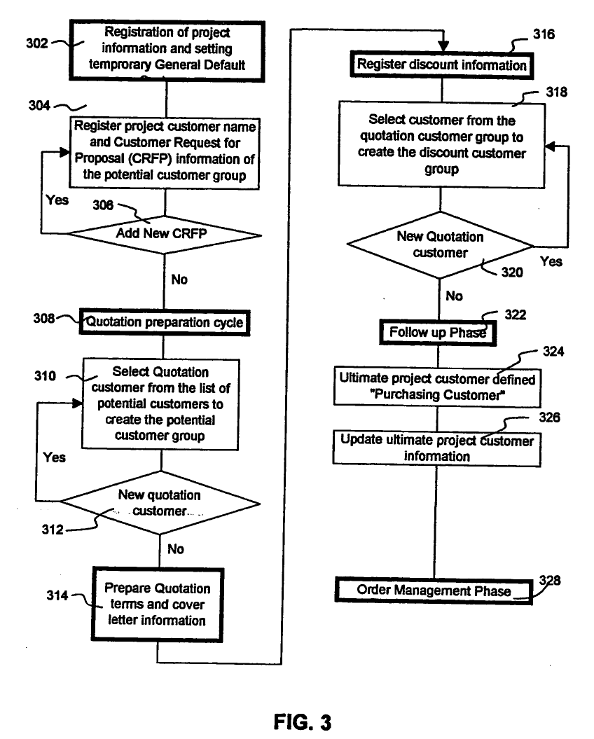

FIG. 3 illustrates a flow diagram for the allocation of multiple customers for a single project. The illustration covers the different phases of the sales process comprising the request registration phase, the quotation generation phases, the follow up phase, and the purchase order phase. The customers of the potential customers group and the end-user are always different entities. The purchasing customer is not determined at the beginning of the sales process and a default general customer is temporary created 302. During the project study, a plurality of customers submits Request for Proposals (CRFP) to form the potential customers group 304: CRFP may cover the entire project scope or only part of it. CRFP may differ in content according to the customer interpretation of the project. The quotation prepared for each customer in this context must therefore be different. During the Quotation preparation 308, the quotation customers subset 310 is selected from the pool of potential customers group 304 but doesn't necessarily cover all potential customers 304.

A different discount level may be provided for each customer of the customers discount group 318. This case is often required when a pre-bid agreement or other special discount agreement exists with one or more customers. In one embodiment of the invention, the agreement information relating the customer to the discount percent is created and maintained at the customer management component 222. In another embodiment of the invention, a set of items is created relating the quotation customer receiving the discount to the discount percent associated with the customer and defined by rules maintained at the customer management component 222. These values may be stored in columns or fields within a larger record structure or a row in a table. Such approach enables high flexibility in addressing different pricing levels and policies in conjunction with different potential customers in the same potential customers group 304.

At early follow up phases 322, after submitting the quotation to the potential customers, the potential customers are following up the award status with the end-user. Once the end-user award the project to a specific customer, he become the purchasing customer 324 and replace the default general customer. The relative project status defining the business status between the customer and the end-user becomes order, however, the project status remains follow up in system 200, until the purchasing customer decide the purchase of the products. The default general customer for the proposal remain unchanged during part of the project follow up phase until the ultimate project customer is defined. Once the ultimate customer 324 is determined, system 200 accept him as a purchasing customer during the remaining follow up phase and possible order phase 328.

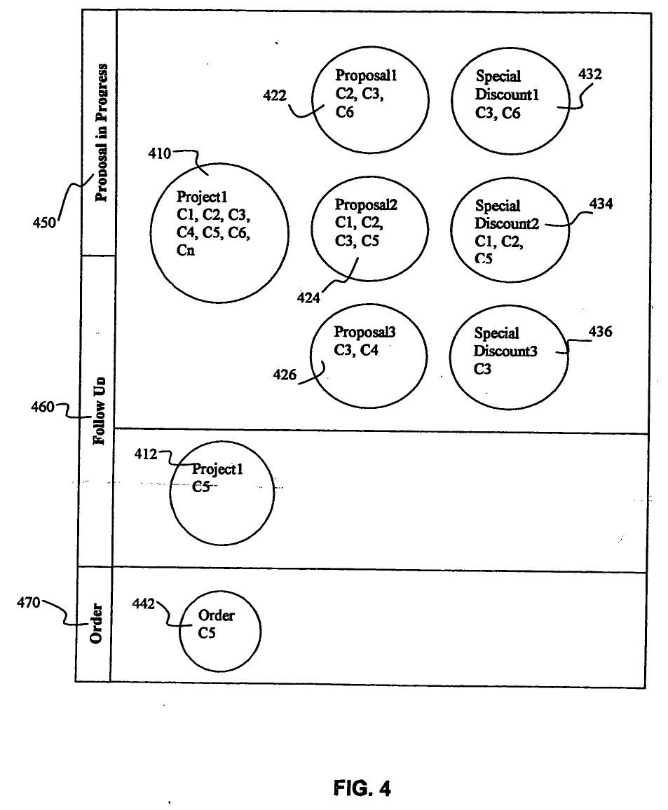

FIG. 4. is a diagram illustrating the change of the customers' patterns with the different sales process phases for a project involving multiple customers' requests. The diagram illustrates the method used by system 200 to efficiently address the customer's pattern variations. Suppose that the potential customer group 304, maintained at the sales project component 212, consists of 6 Customers (C1, C2, C3, C4, C5, C6) requesting quotations for a certain project 410. Potential customers C2, C3 and C6 request quotation Q1 422, Potential customers C1, C2, C3 and C5 request quotation Q2 424, etc. A special discount is granted to Potential customers C3 and C6 for quotation Q1 432, Potential customers C1, C2 and C5 for quotation Q2 434, and Potential customers C3 for quotation Q3 436. As shown in this diagram, the potential customers bound to a specific quotation or receiving a special discount are always a subset of the potential customers group 410. Information relating customers to quotations are maintained at the quotation customer group object. Quotation discounts information are maintained at the customer discount group objects. Both objects are maintained at the quotation management component 226 of system 200. Ultimately, in a later stage, customer C5 wins the project and become the purchasing customer for the sales project 442. System 200 updates this information that become also valid for a possible order.

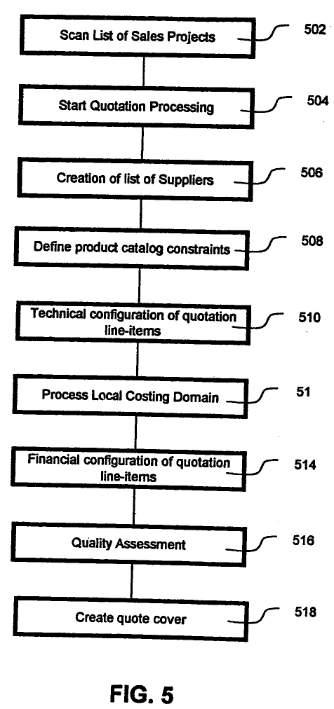

FIG. 5. illustrates an example quotation creation workflow in which a supplier pool is created, product constraints are created, a multiple line-item technical quotation is created, local costing domains are defined in conjunction with suppliers, a financial proposal is completed and a proposal cover is created.

The user of Department 29 scan the list of sales projects that are in progress and choose one project 502. The list of sales projects comprise information based on the customer request information 304 maintained at the sales project component 212. Next the user of Department 29 creates and process information 504 related to the quotation object associated with the sales project and starts creating and processing information related to a set of objects associated with the quotation object. The user starts by the creation of a list of suppliers 506 that will be used for the creation of the quotation and for building local costing domains. Next, the user set catalog products constraints 508 bound to the quotation and based on rules comprising information about product main categories, product subcategories and product suppliers in any suitable combination without limitation. Quotation line-items and sub-items comprise catalog and non-catalog products. Catalog products available for the quotation line-items are either regular catalog products or general supplier products. General supplier products and non-catalog products are identified by the request process for sourcing products and services from suppliers 19A-19D. The catalog products available for the quotation line-items are limited by the quotation rules and by other set of rules related to the customer side through an algorithm stored in the system identifying a preferred set of products for each customer. Next, based on offers received from suppliers 19A-19D and on regular product catalog information, the user access the line-items maintained at the quotation line-items component and continues the technical configuration 510 of the line-items and sub-items. At this phase, the technical proposal is completed and all line-items and sub-items technically configured. Next the proposal local costing domains are processed 512 for line-items and sub-items valuation and for identification of supplier/partner and relevant terms and conditions. The method in conjunction with local costing domain and item valuation is described fully hereinafter. Next, the user returns back to the Quotation line-items to complete the financial section 514 of the line-items and sub-items to obtain the item resale values. Further processing of the quotation line-item object maintained at the quotation management component 216 is described fully below. Next the user check the proposal quality 516 by running a business case analysis. In the last step, the user creates a quotation cover 518 and associate the quotation to the appropriate potential customers.

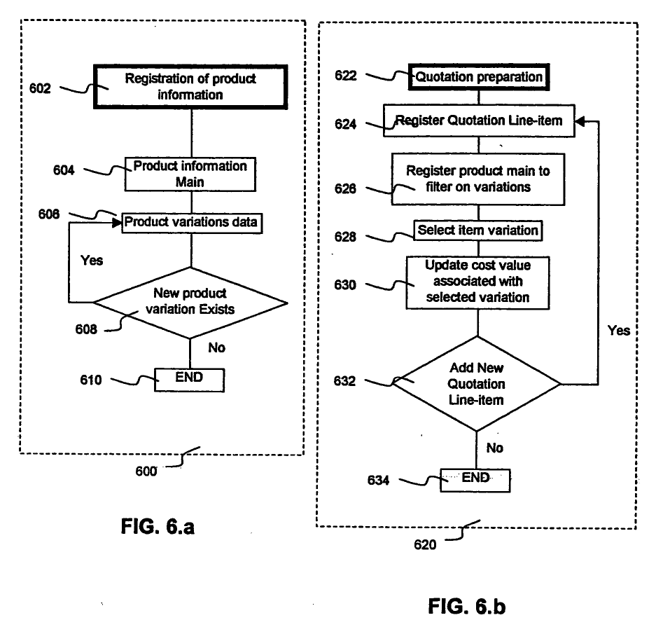

FIG. 6 shows the flow diagram A of products configuration in the Catalog Management Component 226. The configuration method described is associated with the product catalog structure comprising a product object and a product variation object maintained at the catalog management component 226. This method for configuring products simplify the line-item catalog product selection, illustrated in flow diagram B. Flow Diagram B is associated with FIG. 6. The selection of the catalog product of the line-item comprise two steps. In the first step the product is searched and selected from the restricted list defined by rules at the customer side and the quotation side. In one embodiment of the invention, the product is selected from a pull down menu, in another embodiment, the product is selected from a list of products available in a different window and prompted by a user action. This selection results in an automatic filter for the product variations associated with the selected product. Next, the user selects the product variation from the list of variations. Based on the variation selection, the cost price of the product variation is automatically associated to the line-item. The method is particularly efficient in the preparation of large quotations consisting of hundreds of items. Suppose that each product stored in system 200 has an average of 10 variations. By using this method the products are selected from a data pool, which is reduced to 10% of the original data pool size in case each product having different variation is stored as an independent record. Accordingly the method provides a quick and practical way that reduces the time of product search, selection, and association of the product with the line-item.

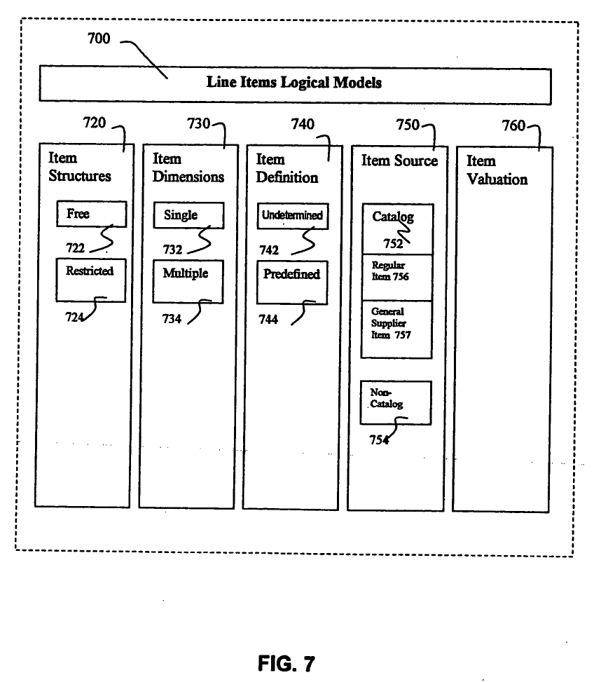

FIG. 7. is a diagram illustrating the logical model for handling complex multi-layers line-items. The diagram illustrates the method used by system 200 to breakdown line-item based objects comprising the quotation line-items object maintained at the quotation management component 216, into logical components. The line item is the building block of the quotation. Five distinguished models are presented in conjunction with line item: Item dimensions 730, Item structures 720, Item definitions 740, Item Source 750 and Item valuation 760. Although the models described are presented in conjunction with the quotation line-items object, the definitions may apply to other line-items based objects.

Item Dimensions 730: Depending on the degree of complexity, each line item in a quotation may consist of one or more layer(s) of sub items. A multi-dimension item 734 is defined as an item with one or more consecutive layer(s) of sub items. A ID element is a simple single item 732, a 2D element is an item spread over 2 layers, a 3D element is spread over 3 layers and so on.

Item Structures 720: Item structures 720 are provided to assist sales professionals of Department 29 for efficient handling of complex items. Item structures 720 may be free item structure 722 or restricted item structures 724. Free item structure 722 is a multi-dimension item not existing in the restricted item structures domain. Free item structures 722 are always rooted to top layer. Restricted Item structures 724 are introduced for handling complex items over 1 or 2 Dimensions. Therefore, a restricted item structure 724 is only defining relations over 1 or 2 layers at the most (primary and secondary). If not originated in the top layer, restricted item structures 724 must exist in the domain of free item structures. Restricted Item structures 724 are: a) Single item with ID element existing outside the domain of other restricted structures, b) Complex Item with 2D element, and c) Subsystems that consists of one or more items with ID or 2D elements.

Item Definitions 740: Item definition 740 describes whether the product or service is associated with the line-item before the configuration process. The line-item is predefined 744 when the product or service is already associated with the line-item. Predefined line-items are stored within a preset library in system 200. A line-item is undetermined 742 as long as it requires product configuration by the user of system 200. The user of system 200 completes the line-item definition of the undetermined line-items during the line-items configuration process. A single line-item structure is undetermined (except when existing in the context of other predefined item structures), a complex item can be either undetermined or predefined. A subsystem is always predefined.

Item Source 750: Products or services offered in a proposal are either existing in the product catalog of the company database or existing outside the product catalog and offered by third party product vendors or service providers based on system 200 user request. Therefore, Item source 750 has two possibilities: Catalog items 752, and non-catalog items 754. Catalog items 752 include tow types: regular catalog products 756 associated with one specific supplier and general supplier products 757 associated with multiple potential suppliers. Catalog items 752 of a specific supplier have cost and validity information bound to the catalog contract. Non-catalog items 754 cost and general supplier products 757 cost are defined in course of the quotation preparation.

Item Valuation 760: Item valuation is defined by the resale value of items and sub items. A Complex item resale value is the sum of total resale values of sub items in the secondary layer.

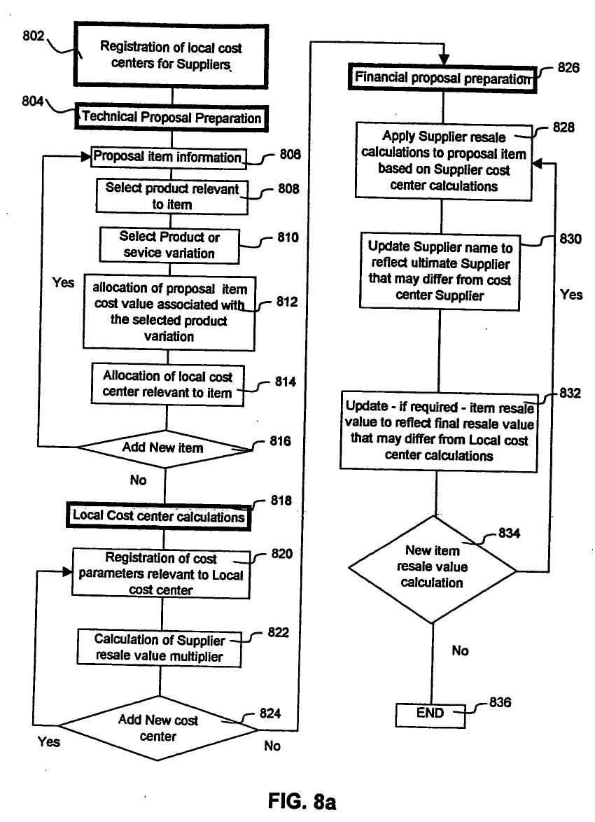

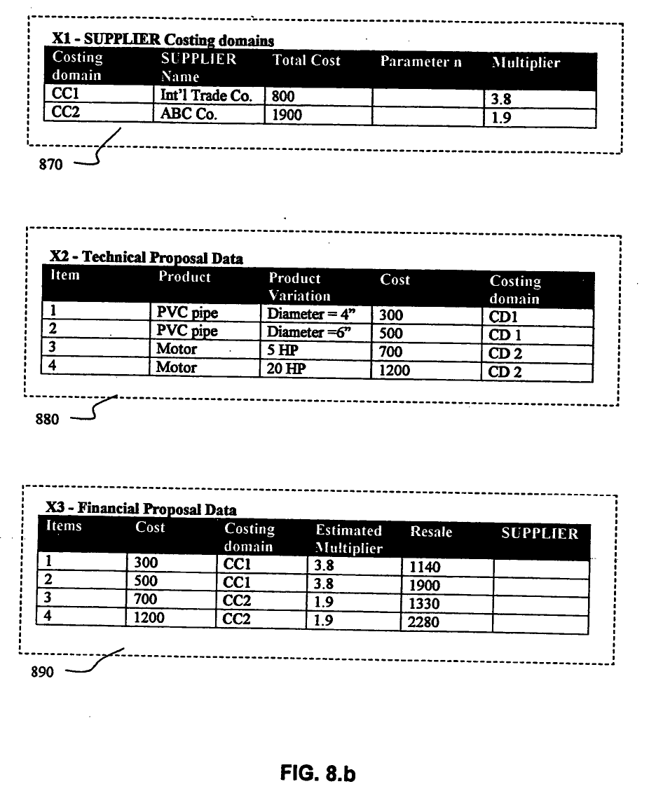

FIG. 8.a. illustrates the basic flow of program code directing the computer to perform the functions of a preferred embodiment of the invention. Local costing domains are associated with suppliers 19A-19D and Trade Partners 18A-18D. A local costing domain is a data structure, such as a table, that relates a variety of information about a supplier and a product or service, as discussed more fully below. System users create new local costing domains for each proposal. Products or services offered in a quotation line-item object are either catalog 752 or non-catalog 754 items. Catalog items are those that are regularly available from one or more suppliers (such as may be found in a supplier catalog) as discussed above. Non-catalog items are any other items, such as items that require special order. Item valuation 760 is affected by currencies, terms, conditions, transportation costs, etc. Local costing domains are used for the quotation line-item valuation 760 and for identification of suppliers and/or Trade Partners and relevant terms and conditions. Usually, local costing domains are created for different suppliers 19A-19D and Trade Partners 18A-18D. However, in some cases, more than one local costing domain has to be created for the same supplier or Trade Partner. Suppose that a supplier is offering a machine and relevant spare parts, and that the local custom percentages for the machine and the spare parts are 10% and 30% respectively. In this case the creation of two local costing domains is necessary to handle the difference in custom percentage, which has a direct impact on the resale multipliers.

FIG. 8.b. illustrates the relation between the local costing domains and line-item configurations. Display 870 represents a supplier local costing domain table. The system computes “total cost” in 870 automatically from individual costs in 880. Parameter n is a reference for other parameters associated with cost calculation, e.g. transportation, customs, and taxes. The multiplier value is calculated based on these parameters. Table 870 comprises an example of two local costing domains. Display 880 represents a Technical quotation line-item table, and Display 890 represents a financial quotation line-item table. The introduction of local costing domains is described hereinafter. The quotation management component 216 (FIG. 2.a) maintains information regarding the local costing domain. Local costing domains contain parameters relevant to a supplier's market conditions. In one embodiment, the definition for the local costing domain object maintained at the quotation management component 216 (FIG. 2.a) may include, in any suitable combination, without limitation, (1) a costing domain identifier (2) a supplier ID, (3) a currency type, (4) transportation cost(s), (5) a total value of a product and/or service, (6) shipping expenses, (7) clearance expenses, (8) a supplier validity period, (9) a validity period for a customer, and/or (10) a multiplier. A local costing domain object may describe a validity period for a resale value of the supplier's products or services based on rules associated with the local costing domain.

As shown in FIG. 8.a, a user of department 29 compiles and registers an initial list comprising costing domain identifiers and relevant suppliers 802 at the costing domain object, thereby producing table 870. Other fields such as the total cost are computed after generation of table 880. In a following step 804, the user processes technical content associated with the quotation line-items object, thereby producing table 880. In step 808, the user enters quotation line-item information and, for each quotation line-item, the user allocates a main product or service as shown in display 880. Also the user selects variations relevant to the product or service 810. The quotation management component automatically determines line-item cost value associated with the selected product or service variation 812. In the next step 814, the user allocates a local costing domain for the line-items from the list of local costing domains defined earlier in the process 802. The steps described above are repeated for each line-item to complete the technical configuration phase.

According to one exemplification of our preferred embodiment, the quotation management component evaluates the resale value of line-items and sub-items using multipliers of the local costing domain 870. During the financial evaluation phase, the quotation management component calculates a supplier resale value multiplier 818 in conjunction with the local costing domain object for each local costing domain of Display 870 (FIG. 8.b). The User Interface Display 870 (FIG. 8.b) derives the value of the multiplier from the cost parameters related to currency, currency risk factor, shipping and transportation cost, customs, local taxation expenses and other expenses. These costs and parameters are entered and defined in the local costing domain object in step 802. The multiplier is calculated based on a formula or equation determined by the parameters entered. The Quotation Financial Data as shown in Display 890 (FIG. 8.b) can be completed by a system operator based on the resale value multiplier computed in conjunction with the local costing domain object. The user repeats the steps described above for the valuation of all quotation line-items and sub-items.

In another exemplification, a database or file system stores the resale value calculation of the quotation line-items and sub-items as a formula or a reference to a function comprising local costing domain parameters. During the financial evaluation phase, the Quotation Management Component calculates supplier resale value formulas using each local costing domain. The Quotation Management Component derives the value from cost parameters related to currency, currency risk factor, shipping and transportation cost, customs, local taxation expenses and other expenses. The Quotation Management Component completes the Quotation Financial Data 890 (FIG. 8.b) based on the resale value formula computed automatically using the local domain object.

In a still further exemplification, a database or file system stores the resale value calculation of the quotation line-items and sub-items as a formula or a reference to a function comprising local costing domain parameters and other parameters related to the line-item. During the financial evaluation phase, the Quotation Management Component calculates supplier resale value for each quotation line-item and sub-item. The Quotation Management Component derives the value from cost parameters related to currency, currency risk factor, shipping and transportation cost, customs, local taxation expenses and other expenses, in addition to parameters related to the line-item or sub-item. The Quotation Management Component completes the Quotation Financial Data 890 (FIG. 8.b) based on the resale value formula.

Special considerations are associated with multi-layer line-items, which comprise one or more sub-items. The Quotation Management Component obtains the resale value for a single (ID element) line-item 732 (FIG. 7) using one local costing domain. Valuation 760 of multi-layer line-items and complex items are indirectly related to local costing domains of the secondary layer. Complex items, also referred to as complex products, have two levels, or layers. Multi-layer line-items can have n layers or levels. Also, complex products are predefined and maintained in the catalog management component. Local costing domains are defined on the level of single dimensions 732 (ID element) items and sub items, and therefore, allow maximum flexibility for cost calculation throughout the item dimensions 730 for different item structures 720 at any item definition 740. For line-items comprising sub items, the local costing domain is never applied on the level of the line-item but is applied on the sub item level instead.

In many situations, the supplier used for local costing domain calculations may be different from the ultimate supplier presented in the quotation line-item. This situation is possible when the sales professional chooses not to reveal to the customer details of the supplier used for cost calculations. In such situations, as an optional feature, a different supplier may be allocated as a substitute for the initially considered supplier used in the local costing domains calculation. This optional method ensures ultimate flexibility in developing the resale value based on market conditions and special vendor conditions

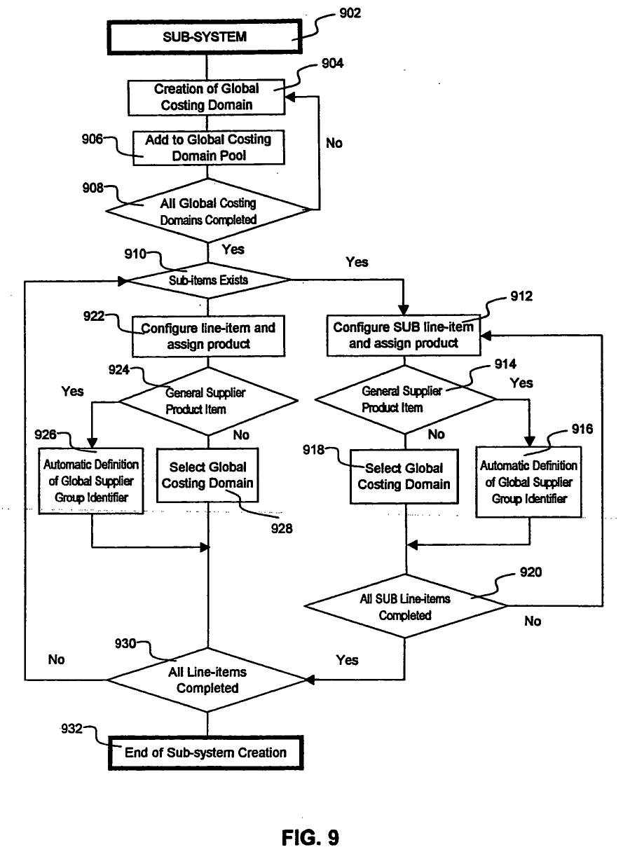

FIG. 9. illustrates an example complex sub-system creation and processing workflow in which a global costing domain pool is created 908, a multiple line-item sub-system is created, Sub-system is saved to sub-system library, sub-system in the quotation is processed, and sourcing requests to third-party suppliers 19A-19D are automatically generated.

During the subsystem creation phase, the user creates and processes information related to the subsystem library object associated with the catalog management component 226 (FIG. 2). Additionally, the user starts creating and processing information related to a set of objects associated with the subsystem library object. Subsystem line-items and sub-items comprise either regular catalog items 756 or general supplier catalog items 757. The user associates global costing domains with regular catalog based items 756, while global group identifiers are associated by the user with general supplier catalog based items 757. The general supplier product is described in detail in following sections. The catalog management component 226 (FIG. 2) maintains information regarding the global costing domain object. The global costing domain object is used for line-item valuation 760 and for identification of supplier and relevant terms and conditions. In contrast to local costing domains, global costing domains are not directly associated with the quotation line-item object. In one embodiment, the definition for a global costing domain object maintained at the catalog management component 226 may include, in any suitable combination, without limitation, (1) a global costing domain ID, (2) a supplier ID, (3) validity information (date or period). Global costing domains are available for all regular catalog based items 756.

The user begins the subsystem creation process by updating the list of global costing domains maintained at the catalog management component 226 as needed. Next, the user accesses the subsystem object and starts the configuration of the line-items 922. The selection of the product of each line-item of the subsystem comprises two steps. In the first step, the product is searched and selected. In one embodiment, the user selects the product from a pull down menu. In another embodiment, the user selects the product from a list of products available in a different window and prompted by a user action. This selection triggers an automatic filter for the product variations associated with the selected product. In the second step, the user selects the product variation from the list of variations. Based on the variation selection, the Catalog Management Component 226 automatically associates the cost price of the product variation to the line-item via an update to the table. The user then selects a global costing domain 928 from the global costing domain list available to each line-item, except for line-items comprising a general supplier product 757.

The Catalog Management Component 226 automatically determines Global Supplier Group Identifiers 926 for general supplier product based items 757. The Global Supplier Group Identifier allows for modeling of a group of suppliers to a general supplier product as described below. In one embodiment, the Catalog Management Component 226 associates the Global Supplier Group Identifier with line-items of the subsystem object. For each general supplier product based item 757, the Catalog Management Component 226 automatically makes available multiple suppliers associated with the global supplier group identifier for the phase of request generation 926 to third-party suppliers 19A-19D. A general supplier product is a product that is sourced or requested from different suppliers. These suppliers are grouped and referenced by the global supplier group identifier. Binding the global supplier group identifier to the line-items comprised of general supplier products enables automatic inclusions of these particular line-items and associated suppliers. This inclusion occurs initially in the quotation line-items and subsequently into the request line-items of the request generation phase as structured by the backbone tree. A user repeats configuration steps for each line-item of the subsystem to complete the subsystem creation 932. In case a sub-item exists 910, the user adopts similar configuration steps on the level of sub-items, leading to Global Costing Domain selection 918 or automatic definition of the Global Supplier Group Identifier 916 for each sub-item.

During the Quotation processing phase, the user prompts the Quotation Management Component 216 to load complex subsystems and incorporate them into the line-items of the quotation line-items. The Quotation Management Component 216 automatically scans local costing domains, maintained at the local costing domain object and associated with the quotation process. Global Costing Domains associated with the subsystems create local costing domains using an algorithm ensuring that the global costing domain reference is unique and the supplier ID is unique. The Quotation Management Component 216 associates local costing domains. Local costing domains are maintained at the local costing domain object. In case the supplier ID is not unique, the algorithm automatically prompts the user to accept the inclusion of a new local costing domain at the local costing domain object or to use an existing one already bound to the same supplier ID. For each line-item of the subsystem that had been incorporated into the quotation line-items object, the Quotation Management Component 216 automatically changes the global costing domain reference to the local costing domain reference generated at the local costing domain object. Based on the same user action, the Quotation Management Component 216 automatically maps general supplier product based items 757 bound to subsystems to the comparison package object 240 for the request processing stage. (This is explained in further detail below.)

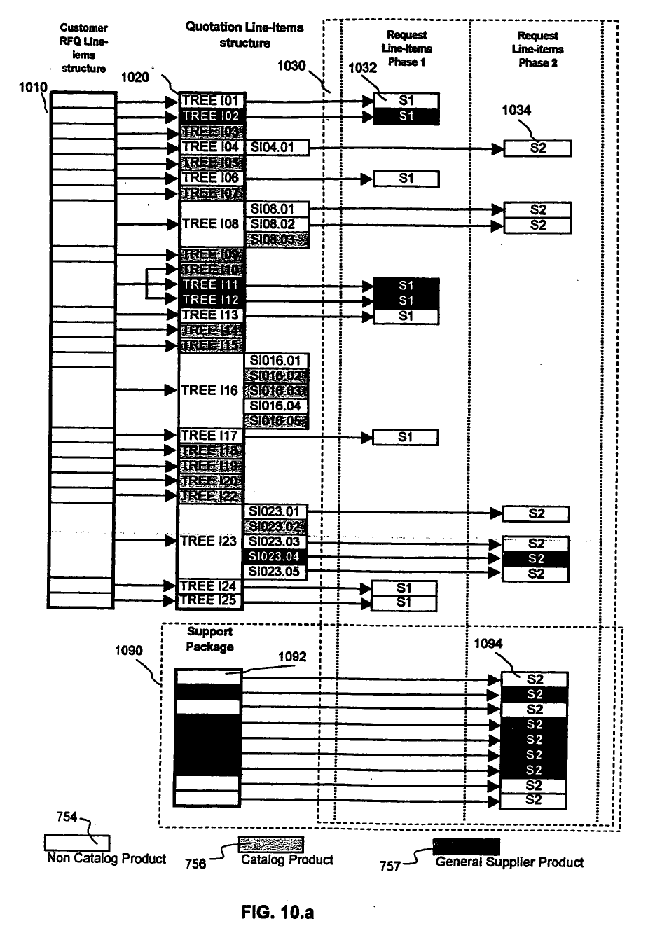

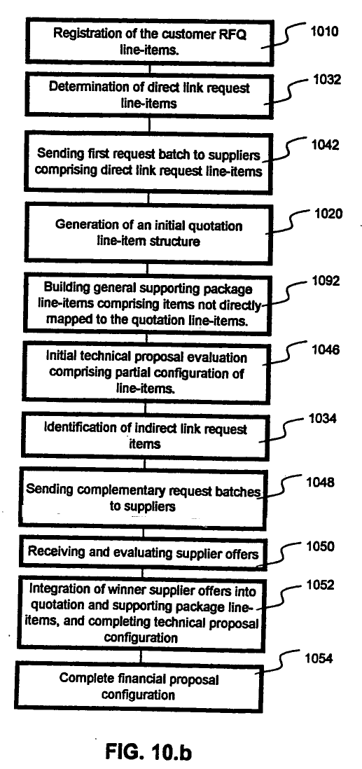

FIG. 10.a. illustrates the Backbone Tree. The Backbone Tree is a data structure or other relationship that relates line-item data objects used in various parts of the system. By way of example, FIG. 10.a illustrates line-item data objects created or maintained by the Sales Project Component 214 (FIG. 2) as Customer RFQ Line Items 1010. FIG. 10 also illustrates line-item data objects created or maintained by the Quotation Management Component 216 (FIG. 2.) as Quotation Line-Items 1020. As illustrated by arrows in FIG. 10.a, the Backbone Tree relates line items of the RFQ to corresponding line items of the quotation. The Backbone Tree defines line-item structures and relations, and it may include references to partially configured line-items at the beginning of the proposal creation process. The Backbone Tree's primary function is establishing relations among line-items of different objects for different phases of the sales process. The process for establishing relations between these references is outlined below. For example, the Backbone Tree can relate the line-item structure of the quotation 1020 ultimately submitted to the customer in response to the customer RFQ to the structure of a general supporting package of request line-items 1092 created earlier in the response process. The general supporting package is comprised of additional line-items not existing in the customer request line-items 1010 and which are created by the user to complete the proposal and request supporting products and services that would not be directly mapped to the quotation items. The supporting package 1090 is used by sourcing professionals to handle sourcing requests to suppliers 19A-19D that cannot be directly mapped to the quotation line-items 1020.

The Backbone tree can be used for mapping various line-item data objects to the quotation line-items 1020 in any suitable combination, including without limitation (1) the RFQ line-items 1010 received from the customer, (2) the sourcing requests 1030 generated for submission to suppliers 19A-19D for general supplier product items 757 and other non-catalog 754 items, (3) the quotation line-items associated with the winning supplier offers (received in response to sourcing requests) and (4) the Purchase order line-items (i.e., line-item data objects created when issuing purchase orders relating to supplier offers). The Backbone Tree may also be used for mapping varying line-items to the supporting package line-items 1092 in any suitable combination without limitation, (1) supporting sourcing requests 1094 generated for submission to suppliers 19A-19D for general supplier product items 757 and other non-catalog 754 items, (2) the quotation line-items associated with the winning supplier offers responding to supporting sourcing requests, and (3) purchase order line-items.

In one embodiment, references to line-items of the basic tree structure are determined partially by the line-item ID of the quotation line-item object maintained at the quotation management component 216. These references are index values provided in tables. The basic tree structure refers to the backbone tree without the supporting package. References are either determined by the user or triggered by the system based upon several conditions. The first condition occurs when a customer's RFQ line-items are either imported or manually entered by the user in table 1. A trigger would then create an initial structure for quotation line-items 1020, in a table 2, similar to RFQ line-items 1010 and accordingly initial references are automatically established between RFQ line-items 1010 and quotation line-items 1020. The user would then manipulate the structure of quotation line-items 1020 during the initial quotation generation phase and introduces complex items, sub-items, and other objects which may be stored in tables. During the same initial quotation generation phase, the user may create the support package 1090, which may also be stored in table 2. Direct link request line items 1032 of phase 1, comprising non-catalog products and general supplier products are triggered by the system and stored in table 3 for sourcing with automatic reference creation and mapping to request line-items 1030. Request line items 1034 and 1094 of phase 2 are automatically triggered in a subsequent phase and may be stored in table 3 with automatic reference creation and mapping to quotation line-items 1020 and general supporting package 1090 respectively. The general supporting package determines references by this series of conditions. The references are also determined in conjunction with the general supporting package 1090 of the request line-items maintained at the request management component 214 and comprising references to line-items set by a line-item ID stored among a larger record structure. In another embodiment, a database or file system stores the basic tree structure comprising a tree identifier, a unique tree line-item identifier, in addition to reference to the quotation line-items 1020 and to the supporting package line-items 1092. RFQ line-items 1010, quotation line-items 1020, and supporting package line-items 1092, which comprise a portion of the backbone tree, are maintained in system 25. Request line items 1032, and indirect link request line-items 1034 and 1094, which also comprise a portion of the backbone tree, may be maintained in one or both of systems 25 and 50. These values may be stored in columns or fields within a larger record structure or a row in a table. Again by way of example, Customer RFQ Line Items 1010 can be a dBase table, Quotation Line-Items 1020 can be represented by parent/child tables, and other sets of line-items 1032, 1034, 1092, 1094 can each be represented each by a table in the database.

According to one exemplification, a database or file system stores an identifier of the tree <Tree Identifier>. The Tree Identifier can be any value and may be based on a formula. In one embodiment, the tree identifier includes the quotation identifier. In another embodiment, the tree identifier includes the project identifier. In a further embodiment, the tree identifier is the quotation identifier. Line-items of the different objects mapped to the tree of quotation line-items 1020 are related to the tree line-item Identifier. These values may be stored in columns or fields within a larger record structure or a row in a table.

Requests for Quotation (RFQ) 304 are received and registered from at least one customer comprising a plurality of RFQ line-items 1010, each corresponding to a product and/or service called for in the RFQ. Each RFQ line-item may have a link to one or multiple line-items in the quotation 1020. The link is called “direct” if the relation is one to one and the quotation line-item is a single item otherwise the link is called “indirect.” The line-item may be locally configured by Department 29 based on regular catalog products, or based on information requested from suppliers 19A-19D through a sourcing mechanism controlled essentially by the Request Management Component 214 (FIG. 2). A line-item subject to a request to a supplier is called a “request line-item.” Request line-items 1030 are maintained at the request line-item object of the Request Management Component 214 (FIG. 2). The source 750 of the request line-items comprises items based on non-catalog products 754 and general supplier catalog products 757. The line-item may include either a non-catalog product or a general supplier catalog product.

FIG. 10.b illustrates the work flow for sourcing and technical configuration phases using the Backbone Tree. Generally, the direct link request line-items 1032 are quickly identified by the sales professional of Department 29 upon receiving and registering the line-items of the RFQ 1010. The direct link request line-items 1032 are automatically use for a first request batch. Request line-items 1032 of phase 1, comprising non-catalog products and general supplier products are triggered by the system and stored in table 3 for sourcing with automatic reference creating and mapping to request line-items 1030. The request batch simply defines the RFQ documents and line-items sent to suppliers. To identify all indirect link request line-items 1034 and 1094, the user generates an initial quotation line-item structure 1020 and builds the supporting package line-items 1092 using different quotation building blocks. The line-items of quotation line-item structure 1020 are automatically triggered and then initially manipulated by the user for obtaining the first request batch. The supporting package line-items are maintained at the quotation management component and is generally part of the quotation line-items object. The supporting package line-items can also exist as a separate table maintained in the quotation management component 216. The user builds the supporting package based on his judgment the say way the user edits the quotation line-items. Supporting packages 1090 comprise only indirect link request line-items 1092. Normally, the indirect link request line-items 1034 and 1094 require longer time for identification using a partial technical evaluation process, and are part of a second request batch. The evaluation process is a manual process performed by the user. However, the system guides the process by identifying the direct link request line-items. The second request batch is complementary to the first request batch and is based on an initial technical proposal evaluation process 1046 extended as needed for defining the indirect link request line-items 1034 and 1094, and comprising a partial configuration of the quotation line-items and sub-items 1020, in addition to partial configuration of the supporting package line-items 1092. Proposal configuration is generally complex. Due to this complexity, two request phases are introduced. A partial configuration is made in quotation line-item structure 1020 based on direct link items only in order to generate an initial request batch. This initial request batch is useful in that a user cannot wait until fully completing the technical evaluation to start the request process all at once as this will delay the overall process. For example, many suppliers will fail to provide their offers prior to the dead-line, which would hold up preparing the technical evaluation, but for the initial request batch. The initial technical evaluation 1046 may comprise the partial configuration of regular catalog product based items 756. The complementary request batches may be created in part based on rules associated with predefined items 744 as explained in details in following sections.

Request information are communicated to suppliers 19A-19D automatically for sourcing indirect products and services. A plurality of suppliers' offers are received 1050 from suppliers 19A-19D based on published request batches, and the winning suppliers are selected after comparing different supplier offers. Information comprising the request line-items specifications, winning supplier ID and cost prices are updated based on the winning suppliers' offer. This comparison is done using the system and the request management component using procedures well known to those in the industry. The request line-item updates are automatically mapped 1052 to the quotation line-items 1020 and the supporting package line-items 1092 of the Backbone Tree. In a common scenario, with reference to FIG. 10a, the information resulting from the comparison process is updated in direct link request line items 1032 and indirect link request line-items 1034 and 1094. This update is done by direct editing in tables of the request line-items or by automatic update based on the table summarizing the outcome of the comparison process. The information and updates are ultimately and automatically propagated through the backbone tree from direct link request line items 1032 and indirect link request line-items 1034 and 1094 to quotation line-items 1020 and the supporting package line-items 1092. Users of Department 29 complete the technical and financial information of the quotation line-items comprising catalog and non-catalog items for final submission to the customer.

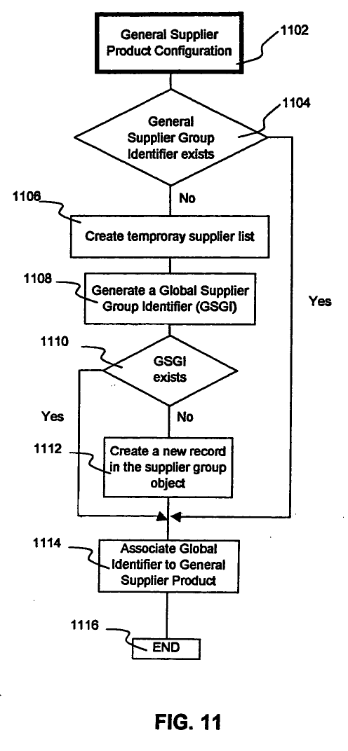

FIG. 11 illustrates a diagram for association of global supplier group identifiers to general supplier products. The global supplier group identifier allows for modeling of a group of suppliers to a general supplier product of the product object maintained at the product management component 226 based on rules bound to the customer (or the customer request information object). The method prevents duplication of groups of suppliers with identical content. A unique global supplier group identifier is associated with a specific geographic location and is particularly useful for modeling of request line-items to the comparison package object 240 and to the request object 260 maintained at the request management component 214 as described in details below.

The Catalog Management Component 226 maintains information regarding the global supplier group identifier object. In one embodiment, a definition for global supplier group identifier object maintained at the catalog management component 226 may include, in any suitable combination, without limitation, (1) a global group ID, (2) a product ID, (3) a global supplier group identifier number, and (4) a territory identifier—the preferred group of suppliers may be different for the same product based on the geographic location. The territory is therefore an important element for defining the global group identifier.

The user selects or creates a general supplier product. This general supplier product is created in the product object at the catalog management component 226 with further reference to the global supplier group identifier object. Next, the user assigns a global supplier group identifier to the general supplier product if a group of preferred suppliers exists. If the global group identifier does not exist 1104 or if the user is not sure about its existence, the following steps are used. First, the user creates a temporary local supplier list 1106 and associates it with the product ID. In one embodiment, the system creates temporary table objects to store the temporary local supplier list, which relates supplier ID's and product ID's in the database or file system. In another embodiment, the temporary local supplier list may be stored in memory or permanent tables. Next, an algorithm outlined in the following paragraph is used to generate a global supplier group identifier 1108. Next, based on the territory identifier, the catalog management component scans the global supplier group identifier numbers to identify if an identical number exists in the global supplier group identifier object 1110. This association is created in the global supplier group identifier in which the product ID is related to the identifier. If the global supplier group identifier number does not exist, the Catalog Management Component automatically creates a new global supplier group identifier record in the global supplier group identifier object for the defined territory. Next, the Catalog Management Component automatically associates a global supplier group identifier to the general supplier product 1114. This association is created in the global supplier group identifier object defined above, in which the product ID is related o the identifier.

In a preferred embodiment of the invention, the global supplier group identifier number is a concatenated string from sorted supplier IDs in an ascending (or descending) order <Suppliers String>, based on the temporary local supplier list. Sorting is based on the temporary local supplier list. In a still further exemplification, the global supplier group identifier is a concatenated string from sorted supplier IDs and the territory identifier <Suppliers string>+<territory identifier>. In one embodiment, the territory identifier is based on rules bound to the customer. In FIG. 2.a, system 200 comprises a customer management component 222 that maintains information about the customer including customer territory and other customer information. Accordingly, the territory identifier existing for a specific customer can be used as a criteria for relating a specific list of suppliers to a particular customer in a given territory. In another embodiment, the territory identifier is based on rules bound to the customer request information object maintained at the sales project component 212. The territory of the project or customer request may not necessarily be the territory of the customer. In this case, the territory identifier may be obtained by information or rules stored in the customer request information object. Rules may be stored in database tables to decide for example the inclusion of the customer territory or the project territory or both. Information stored in database tables relating the territory identifier to customer ID in one embodiment or to the customer request information object in another embodiment, may be stored in columns or fields within a larger record structure or row in a table.

In one embodiment, the Catalog Management Component automatically creates and stores a set of items relating global group ID to supplier ID in a table in the data base or file system. These values may be stored in columns or fields within a larger record structure or row in a table. To update the supplier group content associated with a general supplier product, the user loads a list of items relating the global group ID to supplier ID to a temporary local table or file system comprising the suppliers list associated with the product ID. After the user updates the content of the temporary list, the Catalog Management Component creates a new global supplier group identifier and the steps are repeated for association of a new global group identifier to the same general supplier product.

In another embodiment, the Catalog Management Component uses an algorithm to ungroup the global supplier group identifier and establish the relation between the Supplier ID and the global group ID. The algorithm is a function or a computer routine for splitting the concatenated string and breaking it into its initial components, e.g. Supplier ID's. To update the supplier group content associated with a general supplier product, the Catalog Management Component ungroups the global supplier group identifier from original suppliers IDs using the algorithm and loads the global supplier group identifier to a temporary local table or file system comprising the suppliers list associated with the product ID. After updating the content of the temporary list, the user creates a new global supplier group identifier and repeats the steps for association of a new global group identifier to the same general supplier product.

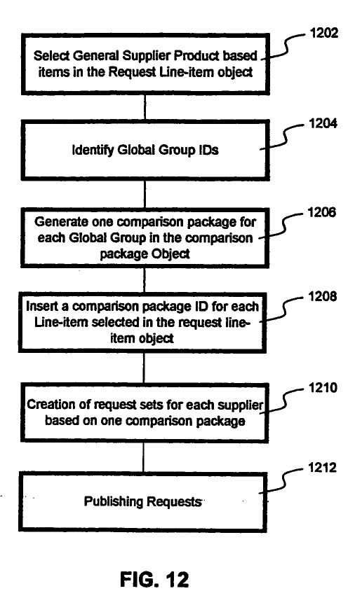

FIG. 12 illustrate a diagram for automatic generation of sourcing requests 260 associated with general supplier product based items 757. Requests associated with sourcing products and services from third party comprise (1) request creation, (2) request communication, and (3) suppliers offers evaluation. The construction of the backbone tree is the base for processing sourcing operations. Depending on the request batch phase, the user generates direct link request line-items 1032 associated with the quotation items or indirect link request line-items 1034 associated with the quotation sub-items and request line-items associated with the supporting package items 1094 of the backbone tree. Request line-items 1030 are either non-catalog 754 items or general suppliers product based items 757. General supplier product based items 757 are characterized by the presence of a global group identifier used for modeling of a preferred group of suppliers associated with the requested product. Suppliers 19A-19D of system 100 comprise the suppliers of the global group identifier receiving the requests. The catalog management component 226 maintains information regarding the global group identifier.

In one embodiment of our invention, an algorithm is used to group the request line-items into one or more consistent package maintained at the comparison package object 240 and comprising reference to compatible request line-items that can be completely sourced from any supplier of the targeted comparison package suppliers. Since the comparison package is the base for comparison of the supplier offers to decide the package winner, the number of line-items in each comparison package must be optimized to make sure that all the targeted suppliers associated with the comparison package are able to fulfill all the items requested for accurate offers comparison on similar basis.

During the request creation stage, the general suppliers product based items 757 each comprising a global group identifier and maintained at the request line-item object 1030 are automatically identified and selected. In FIG. 2.b selected request line-items are grouped by the global group identifier using the comparison package object 240 maintained at the request management component 214. Each set of the requested line-items 1030 is associated with one comparison package at the most. Therefore, each request line-item can only be associated with one comparison package. For each global group identifier, a comparison package ID is identified in the comparison package object 240. Using the comparison package IDs, comparison packages are mapped to the request line-items object 1030 and to the request object 260. For each comparison package of the comparison package object 240, request sets maintained at the request object 260 are created for each supplier of the global suppliers group.

In conjunction with non-catalog 754 items, further comparison packages are generated by the user of Department 29 as needed and stored in the comparison package object 240. Comparison packages are then associated to items of the request line items object 1030. One or more supplier is identified for each comparison package and a request is created for each supplier and stored at the request object 260.

During the request communication stage, Sourcing request information comprising non-catalog 754 items and general supplier product based items 757, are communicated to the suppliers 19A-19D using email for notification and request line-items are automatically attached to the email. Request information are also posted on the web system 50 for possible access by the suppliers 19A-19D using a login interface. Other request documents may also be attached to the email and posted to the web system 50.

During the supplier offers evaluation stage, comparison of suppliers offers received by one or more supplier of the global group identifier is done on the level of each comparison package for deciding the winner supplier for the line-items associated with the comparison package. Offers received by suppliers 19A-19D in response to sourcing requests are either posted directly by the suppliers 19A-19D on the web system 50 or entered directly into system 50 by the sourcing professional of Department 29 based on the supplier offer communicated by email, fax, or other traditional means. Suppliers' offers are compared and the winners are identified based on rules in system 50 and the decision of the sourcing professional. In one embodiment of the invention, the line-items of the request line-items object 1030 comprising specifications, supplier ID and cost prices are updated based on the winner suppliers' offer. In another embodiment of the invention update information may be stored in columns or fields within a larger record structure or row in a table. The request line-items updates are automatically mapped to the quotation line-items 1020 and the supporting package line-items 1092 of the backbone tree in system 25.

The creation of a quotation comprising a single line-item associated with a global group identifier is hereby presented by means of the following non-limiting example. A line item #(001) is initially created and stored in the quotation line-item table based on the customer request for a specific product. The user selects the product from the product catalog, which in this case is a general supplier product. Accordingly, the product and a list of suppliers are associated with line item #(001) of the quotation via the global supplier group identifier. The user quits the quotation preparation temporarily to finish a sourcing task. Since line item #(001) can be procured by many suppliers, a number of requests equal to the number of suppliers is automatically generated to those suppliers who are defined by the global supplier group identifier. The request line-item associated with #(001), which is normally stored in a different table, comprises the information of line-item #(001). The different suppliers respond to the request by sending offers for the product. A comparison is done by the user and a particular supplier and a winning supplier is selected. In the quotation table, the winning supplier is associated to the quotation line item #(001) and accordingly the supplier ID, cost, and other information are defined for line item #(001). Then, the resale value is then determined for line-item #(001) using the local costing domain, which is not directly related to the global supplier group identifier. The ultimate selection of a particular supplier from the list stored at the catalog management component for a quotation is a complex procedure that involves the quotation management component and the request management component, through which the winner is decided. This process involves the backbone tree and other methods described.

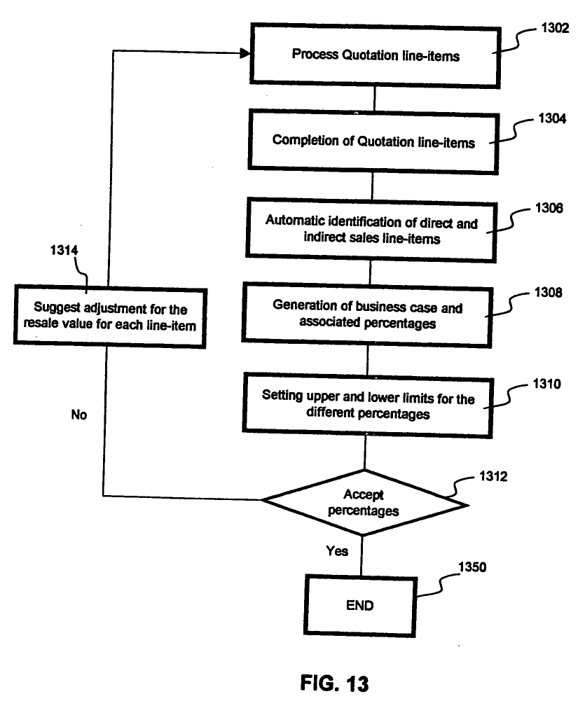

FIG. 13 illustrates the business case generation workflow. Business case calculations are associated with the quotation line-item object. Line-items and sub-items may comprise a combination of direct and indirect sales items. Calculations are performed on the level of each line-item for all dimensions 730. Indirect sales line-items are those line-items associated with third-party vendors and service providers. After the completion of line-items valuation 760, totals for cost prices and totals for resale prices associated with indirect sales are calculated for each product category for the relevant line-items and sub-items. Furthermore, totals for cost prices and totals for resale prices associated with direct sales are also calculated for each product category for the relevant line-items and sub-items. Totals for Products and totals for services are selected separately and grouped for direct sales and for indirect sales items. Sets of percentages of totals 1308 in conjunction with combinations of cost and resale, direct sales and indirect sales, products and services, etc. are determined automatically by system 200. In one embodiment of our invention, calculated percentages may comprise the Sales Gross Profit (SGP) percentage. SGP is the percent of (total resale—total cost) divided by the total resale. An upper and a lower limit are set for each percentage 1310. Calculated percentages are compared to the relevant upper and lower limits, in order to identify if the values are accepted or rejected 1312.

In one exemplification of our invention, a database or file system stores the upper and lower limits as a value. There may exist one value for all upper limits and another value for all lower limits or different values for different sets of limits in the model. Later, the program compare the actual percentages to the relevant upper and lower limits, and identifies if the actual percentages are accepted or rejected.

In another exemplification of our invention, a database or file system stores the upper and lower limits as a formula or a reference to a function. That is, the upper and lower limits might not be known when system 200 generates the business case. Rather, the line-items describe a function which may be executed during the execution of this invention general algorithm. There may exist one formula for all upper and lower limits or different formulas for different sets of limits in the model. Later, the program execute the formulas for obtaining the upper and lower limits, compare the actual percentages to the relevant upper and lower limits, and identifies if the actual percentages are accepted or rejected.

In one exemplification of our invention, based on upper and lower limits determined by rules stored in system 200 for different cases, system 200 automatically suggest the adjustment of the resale values for each line-item and sub-items of the quotation line-items object in order to meet the limits by applying a different fixed percentage calculated for each case using a linear distribution.

In another exemplification of our invention, a database or file system stores the adjustment for resale value of the quotation line-items and sub-items as a formula or a reference to a function. That is, the adjustment for the resale values might not be known when system 200 generates the upper and lower limits for each case. Rather, the line-items describe a function which may be executed during the execution of this invention general algorithm. There may exist one formula for all line-items and sub-items or different formulas for different line-items and sub-items. Later, the program execute the formulas and automatically suggest the adjustment of the resale values for each line-item and sub-item of the quotation line-items object.

In a still further exemplification of our invention, the adjustment for resale value of the quotation line-items and sub-items is based on rules comprising parameters associated with the local costing domain object. Such rules automatically suggest the adjustment of the resale value for each line-item and sub-item of the quotation line-items object.

While the invention has been described with respect to certain preferred embodiments and exemplifications, it is not intended to limit the scope of the invention thereby, but solely by the claims appended hereto.

I claim:

1. A method using a data processing system with a backbone tree for use in preparing a quotation to a potential customer, comprising:
(a) establishing quotation line item objects in a data processing system, each quotation line item object identifying a quotation line item for which a quotation is to be prepared and additional information about the quotation line item;
(b) establishing at least one request line item object in the data processing system, each request line item object identifying a request line item for obtaining a quotation from a sub-supplier and additional information about the request line item;
(c) creating in the data processing system a backbone tree, said backbone tree linking each request line item object to a quotation line item object; and
(d) generating a request to a sub-supplier for a sub quotation for a request line item, said request including information obtained from the request line item object.

2. The method of claim 1, wherein the backbone tree comprises a relational database linking a field of the quotation line item and a field of a request line item.

3. The method of claim 1, further including a step of establishing a set of quotation line item objects in the data processing system, each quotation line item object identifying a quotation line item for which a quotation is to be prepared.

4. The method of claim 3, further including a step of generating a proposal, said proposal incorporating information from a quotation line item object.

5. The method of claim 3, wherein the backbone tree further links a quotation line item object to a request line item object.

6. The method of claim 5, further including a step of generating a proposal, said proposal incorporating information from a request line item object.

7. The method of claim 6, wherein the information from a request line item object includes information entered into a request line item object from a responses from a sub-supplier to a request.

8. The method of claim 1, further including a step of establishing product objects in the data processing system, each product object identifying a product available from a supplier and additional information about the product.

9. The method of claim 8, further comprising a step of linking a product object to a quotation line item object.

10. The method of claim 9, wherein the proposal includes information from a product object.

11. The method of claim 10, wherein the product object designates the product as a product available from a specific supplier.

12. The method of claim 10, wherein the product object designates the product as a product available from a plurality of suppliers.

13. The method of claim 12, further including a step of establishing a global supplier group identifier in the data processing system, said global supplier group identifier identifying a plurality of suppliers from which a product is available.

14. The method of claim 13, further comprising a step of linking a product object to a global supplier group identifier object.

15. The method of claim 1, further including a step of establishing a set of RFQ line item objects in the data processing system, each RFQ line item object associated with a request for quotation, each RFQ line item object identifying an RFQ line item for which a quotation is to be prepared and additional information about the RFQ line item.

16. The method of claim 15, wherein the backbone tree links an RFQ line item object to a proposal line item object.

17. The method of claim 15, wherein the backbone tree links an RFQ line item object to a request line-item object.

18. The method of claim 15, wherein the backbone tree links an RFQ line item object to a product object.

19. A method using a data processing system with a global supplier group identifier for use in preparing a quotation to a potential customer, compromising,
(a) establishing a product object in the data processing system, said product object identifying a product available from a plurality of sub-suppliers;
(b) establishing a global supplier group identifier in the data processing system, said global supplier group identifier identifying a plurality of suppliers from which the product of the product object is available.
(c) establishing at least one request line item object in the data processing system, each request line item object identifying a request line item for obtaining a quotation from a sub-supplier and additional information about the request line item;
(d) establishing a link in the data processing system between the request line item object and the product object; and
(e) for each supplier identified in the global supplier group identifier, generating a request for sub quotation for the request line item, said request including information obtained from the product object.

20. The method of claim 19, wherein the product is a service.

21. The method of claim 19, wherein the step of establishing a link includes a step of creating, in a relational database, a link between a field of the global supplier group identifier and a field of the product object.

22. A method using a data processing system with a global costing domain for use in preparing a quotation to a potential customer, compromising:
(a) establishing a product object in the data processing system, said product object identifying a product available from a sub-supplier;
(b) establishing a global costing domain object in the data processing system, said global costing domain object identifying cost information about the product;
(c) establishing quotation line item objects in a data processing system, each quotation line item object identifying a quotation line item for which a quotation is to be prepared and additional information about the quotation line item;
(d) generating, from the global costing domain object, a local costing domain object, said local costing domain object including cost information from the global costing domain object and costing information related to the product supplier,
(e) linking the local costing domain object to the quotation line-item object; and
(f) generating a proposal, said proposal incorporating information from a quotation line item object.

23. The method of claim 22, further including steps of:
establishing a subsystem object in a data processing system, said subsystem object identifying a subsystem for quotation and additional information about the subsystem; and
establishing a plurality of subsystem line item objects in the data processing system, each subsystem line item object identifying a subsystem line item for quotation and additional information about the subsystem line item, at least one of said subsystem line item objects identifying the product of the product object.
